(19) United States
(12) Patent Application Publication
(10) Pub. No.: US 2004/0181450 A1
(43) Pub. Date: Sep. 16, 2004

(54) System for collecting marketing information

(76) Inventors: Hitoshi Yamada, Kawasaki (JP); Mitsunori Fukazawa, Kawasaki (JP)

Correspondence Address: KATTEN MUCHIN ZAVIS ROSENMAN, 575 MADISON AVENUE, NEW YORK, NY, 10022-2585, US

(21) Appl. No.: 10/785,240

(22) Filed: Feb. 24, 2004

(30) Foreign Application Priority Data
Mar. 14, 2003 (JP) 2003-069858

(51) Int. Cl. G06F 17/60; G06K 19/06

(52) U.S. Cl. 705/14

(57) ABSTRACT

A system for collecting marketing information enables manufacturers to efficiently gather marketing information and provide incentives to customers for the information. A retail store writes read-permission information in information storage media of a product at the time of checkout (step S2). A customer reads product identification information from the information storage media of a purchased product on condition that the information storage media stores the read-permission information (step S3). The customer transmits the product identification information and his/her customer information from a customer terminal (step S4). A manufacturer server receives the product identification information and the customer information from the customer terminal (step S5) and stores them in a relational structure, and also manages the provision status of incentives offered to the customer providing the information.

### BACKGROUND OF THE INVENTION

(1) Field of the Invention

The present invention relates to a system enabling product providers to gather marketing information and to provide incentives to information providers.

(2) Description of the Related Art

Product manufacturers necessarily have to gather customer information on customers who bought their products for sales promotion of their existing products and development of new products. The customers, on the other hand, expect benefits such as discount coupons or free gifts in return for the information.

At present, mainly retails selling products gather customer information. Cashiers obtain product identification by reading the barcodes of the products and additionally enter the ages and sexes of customers as product information into cash registers at the time of checkout, so that the products and customers can be related to each other. As an alternative method, retails may issue customer cards storing registered customer information to customers. By reading the customer cards at the time of checkout, the retails can gather more detailed customer information. At this time, the retails may offer services such as discount coupons or free gifts according to payment price.

To gather customer information, the manufacturers generally conduct mail-in sweepstakes in which customers who bought their products mail personal information with tokens or barcodes of the products and the manufacturers provide these customers with free gifts. Alternatively, the manufacturers may directly sell products on their Web sites over the Internet, not via retails, to electrically gather customer information.

As a conventional system in which customers who bought products apply for services provided by the manufacturers and the manufacturers offer the services to the customers, the manufacturers may use a point incentive system as disclosed in Japanese Unexamined Patent Publication No. 2002-245319. In this system, every target product has an entry number hidden by wrapping or by using a scratch card. After the customers buy the products, they access the manufacturers' Web sites over a network to enter the entry numbers and their personal information. As a result, the manufacturers are able to gather marketing information, and accumulate and manage the points corresponding to the entry numbers for every customer to offer services according to the accumulated points.

The retails use customer information gathered by using barcodes and customer cards issued by them for their own. The manufacturers find difficult in making contract with every retail to get the customer information. In addition, in the above method of gathering customer information with the barcodes or tokens of products via mail, customers will get tired of writing customer information on a card and posting it, resulting in gathering fewer information. In addition, the manufacturers have to electronically organize the customer information, with the result of increased personnel costs.

The manufacturers' direct sales over the Internet eliminates the above problems and results in effectively gathering customer information. This direct sales, however, is not commonly used and cannot be adopted for all products. Then another method can be considered, in which customers electronically read the barcodes or the like of products that they purchased and send them to the manufacturers through a network. In this method, however, the manufacturers cannot find such invalid actions that the customers only read the barcodes at stores without buying the products and electronically sent them to the manufacturers.

In the aforementioned point service system as disclosed in Japanese Unexamined Patent Publication No. 2002-245319, entry numbers and customer information are sent electronically and customers have to buy products to get the entry numbers hidden by wrapping or by using scratch cards. However, to send information including the hidden entry numbers, the customers have to reveal the entry numbers and enter the information by themselves. In addition, since the hidden information are first revealed by customers, retails cannot share these information even though these are specially attached.

### SUMMARY OF THE INVENTION

This invention has been made in view of the above points, and intends to provide a system for collecting marketing information which enables product providers to efficiently gather customer information on customers who bought their products and provide incentives to the customers in return for the information.

To accomplish the above object, there provided a system for collecting marketing information which enables product providers to gather marketing information on their products and provide incentives to information providers. This system is composed of information storage media with a product, a retail terminal, and a product provider server. Information storage media stores at least product identification (ID) information. The retail terminal includes an information writer for writing read-permission information in the information storage media to allow the product ID information to be read. The product provider server comprises: a customer information receiver for receiving the product ID information read from the information storage media of the product having the read-permission information stored therein and customer information on a customer who purchased the product, from a customer terminal of the customer; and an information management unit for storing the received product ID information and customer information in a relational structure and for managing the provision status of the incentive offered to the customer who provided the product ID information and the customer information.

As another aspect, this invention provides a system for collecting marketing information which enables product providers to gather marketing information on their products and provide incentives to information providers. This system comprises information storage media with a product, a retail terminal, and a product provider server. Information storage media stores at least product identification (ID) information of the product. The retail terminal comprises: an information reader for reading information from the information storage media of the product; and an ID information transmitter for transmitting the read product ID information at the time of checkout. The product provider server comprises: an ID information receiver for receiving the product ID information from the retail terminal; a customer information receiver for receiving the product ID information read from the information storage media of the product and customer information on a customer who purchased the product, from a customer terminal of the customer; a sales recognition unit for identifying the product ID information and customer information received from the customer terminal as valid information on condition that the same product ID information has arrived from the retail terminal, and allowing an incentive to be provided to the customer; and an information management unit for storing the product ID information and the customer information from the customer terminal in a relational structure and for managing the provision status of the incentive offered to the customer.

The above and other objects, features and advantages of the present invention will become apparent from the following description when taken in conjunction with the accompanying drawings which illustrate preferred embodiments of the present invention by way of example.

### BRIEF DESCRIPTION OF THE DRAWINGS

FIG. 1 shows the principle of the present invention.

FIG. 2 shows a system for collecting marketing information according to the first embodiment of this invention.

FIG. 3 shows the data structure in a wireless identification (ID) tag of the first embodiment of this invention.

FIG. 4 is a functional block diagram of a manufacturer server of the first embodiment of this invention.

FIG. 5 shows the data structure in a product database (DB) of the first embodiment of this invention.

FIG. 6 shows the data structure in a customer DB of the first embodiment of this invention.

FIG. 7 shows the data structure in an incentive DB of the first embodiment of this invention.

FIG. 8 is a functional block diagram of a cash register of the first embodiment of this invention.

FIG. 9 is a flowchart showing a checkout process of the cash register in the first embodiment of this invention.

FIG. 10 is a functional block diagram of a portable telephone applied as a customer terminal of the first embodiment of this invention.

FIG. 11 shows the data structure in an ID DB of the first embodiment of this invention.

FIG. 12 is a flowchart of a process of the portable telephone after purchase of a product in the first embodiment of this invention.

FIG. 13 is a flowchart of a customer registration process in the first embodiment of this invention.

FIG. 14 shows a system for collecting marketing information according to the second embodiment of this invention.

FIG. 15 is a functional block diagram of a cash register of the second embodiment of this invention.

FIG. 16 is a functional block diagram of a portable telephone applied as a customer terminal of the second embodiment of this invention.

FIG. 17 is a functional block diagram of a manufacturer server of the second embodiment of this invention.

FIG. 18 shows the data structure of a product DB of the second embodiment of this invention.

FIG. 19 is a flowchart showing a process of a manufacturer server receiving an incentive request from a customer terminal in the second embodiment of this invention.

FIG. 20 shows a system for collecting marketing information according to the third embodiment of this invention.

FIG. 21 is a functional block diagram of a cash register of the third embodiment of this invention.

FIG. 22 is a functional block diagram of a portable telephone applied as a customer terminal of the third embodiment of this invention.

### DESCRIPTION OF THE PREFERRED EMBODIMENTS

Preferred embodiments of the present invention will be described below with reference to the accompanying drawings.

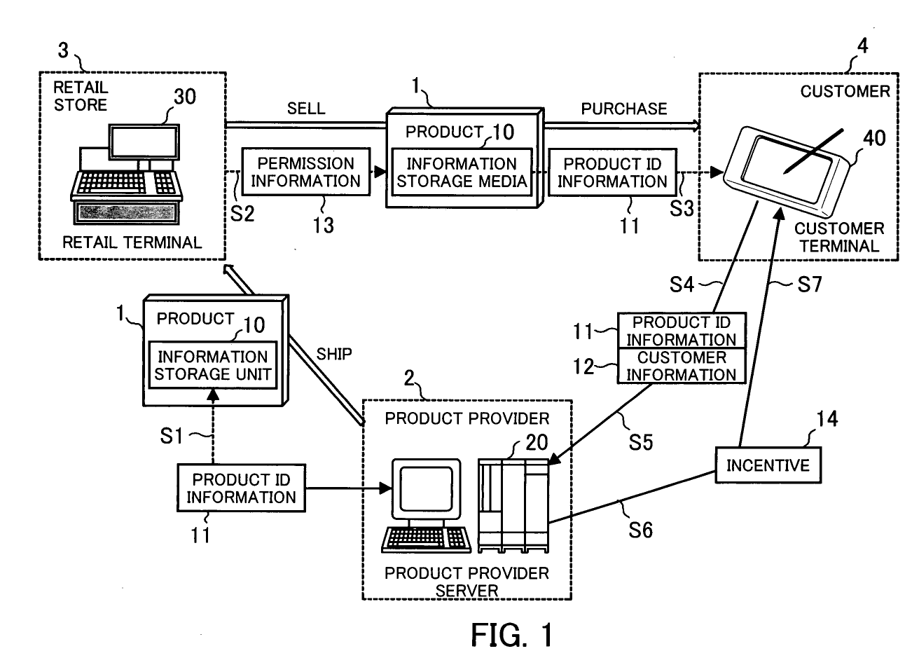

FIG. 1 shows the principle of this invention.

Referring to FIG. 1, a system for collecting marketing information according to the present invention is applied for a network comprising a product provider 2 providing a product 1, a retail store 3 selling the product, and a customer 4 who purchases the product. The product provider 2 is, for example, a manufacturer which manufactures the product 1, and sells the product 1 to the customer 4 via the retail store 3. When the customer 4 buys the product 1, the product provider 2 is able to collect marketing information on the customer 4 and provide some incentives to the customer 4 providing the marketing information.

In this system for collecting marketing information, each product 1 is assigned product identification (ID) information 11 identifying the product. This product ID information 11 is stored in information storage media 10 as well as being registered in a product provider server 20. The product 1 with the information storage media 10 is shipped to the retail store 3. The information storage media 10 is, for example, a wireless ID tag or a two-dimensional barcode, and is attached on the wrapping or case of the product 1.

The product provider 2 has the product provider server 20 for managing information on products and customers and the provision status of incentives. The retail store 3 has a retail terminal 30 for checkout. The retail terminal 30 is arranged as a part of a cash register of the retail store 3 or is connected to the register.

The customer 4 has a customer terminal 40 for informing the product provider 2 of the product ID information 11 of the purchased product 1 and his/her customer information 12. The customer terminal 40 is desirably a portable information processing device such as a portable telephone or a personal digital assistant (PDA). The customer terminal 40 is connected to the product provider server 20 via a communication circuit not shown to communicate marketing information composed of the product ID information 11 and the customer information 12, and incentive information.

In such a system for collecting marketing information, the customer 4 who bought the product 1 reads and obtains the product ID information 11 from the information storage media 10 of the product 1 with the customer terminal 40.

Then the customer terminal 40 sends the obtained product ID information 11 to the product provider server 20 together with the customer information 12 on the customer 4. The customer information 12 includes personal information such as customer's age, sex and occupation. Instead of this information 12, the customer 4 can enter a customer ID received by previously registering with the product provider 2.

The information sent from the customer terminal 40 are received and stored in the product provider server 20. Thus the product provider 2 is able to obtain marketing information indicating what kind of customer 4 bought the product 1. In addition, the product provider 2 provides an incentive to the customer 4 in return for the information. The provision status of incentives offered to the customer 4 is also managed by the product provider server 20. Incentives which can be sent as electronic data are transmitted from the product provider server 20 to the customer terminal 40.

As described above, the customer 4 can electronically obtain the product ID information 11 via the information storage media 10 of the product and send the product ID information to the product provider server 20 via the communication circuit with the customer terminal 40, so that the customer 4 who bought the product 1 informs the product provider 2 of marketing information with a simple process to apply for an incentive. Thus the customer 4 can easily obtain the incentive while the product provider 2 can effectively gather a larger number of marketing information.

In this system, however, the customer 4 can get the product ID information 11 with the customer terminal 40 at the retail store 3 without purchase. To prevent this action, for example, this invention is arranged so that the customer 4 can get the product 1 after the retail terminal 30 of the retail store 3 performs some processes so as to prove that the product 1 has been sold.

As an example, when the retail store 3 sells the product 1, the retail terminal 30 writes read-permission information 13 in the information storage media 10 so as to allow information to be read from the media 10. If the information storage media 10 does not have the read-permission information 13, the customer terminal 40 cannot read the product ID information 11.

A flow of this system will be now described with reference to FIG. 1.

The product provider 2 stores the product ID information 11 in the information storage media 10 of the product 1 before shipping (step S1). At this time, this ID information 11 is also stored in the product provider server 20.

When the customer A buys the product 1, the retail store 3 writes the read-permission information 13 in the information storage media 10 with the retail terminal 30, so that the purchase of the product 1 is proved (step S2).

After the purchase of the product 1, the customer 4 reads data from the information storage media 10 with the customer terminal 40 (step S3). At this time, the customer terminal 40 can read the product ID information 11 on condition that the information storage media 10 stores the read-permission information 13. The customer terminal 40 sends the product ID information 11 together with the customer information 12 to the product provider server 20 through the communication circuit (step S4).

The product provider server 20 receives and manages the product ID information 11 and the customer information 12 from the customer terminal 40 in a relational structure (step S5). Then, in a case where an incentive corresponding to this product 1 can be sent as electronic data, this electronic data (incentive information 14) is transmitted to the customer terminal 40 (step S6). The customer terminal 40 receives this incentive information 14 (step S7), so that the customer 4 can use the incentive.

According to the above process, the product provider 2 is able to determine the validly of marketing information received from customers 4 and to offer the incentives to only customers 4 who actually bought products 1.

As a result, with.:this system for collecting marketing information according to this invention, the product provider 2 is able to effectively collect marketing information and offer incentives to customers 4. Since the customers 4 can apply for incentives easily, more customers may send marketing information. Thus the product provider 2 can develop new products based on a larger number of marketing information, resulting in promoting sales.

Next, the preferred embodiments of this invention will be described in detail.

### (1) FIRST EMBODIMENT

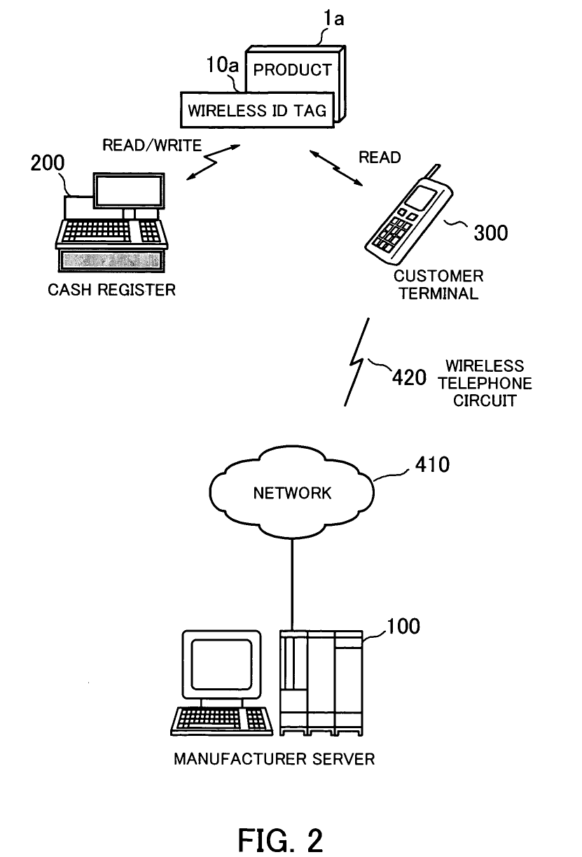

FIG. 2 shows a system for collecting marketing information according to the first embodiment of this invention.

Referring to FIG. 2, a system for collecting marketing information according to this invention is composed of a manufacturer server 100 of a manufacturer providing a product la, a cash register 200 of a retail store selling the product la, which performs a checkout process, and a customer terminal 300 of a customer who buys the product 1a. The manufacturer server 100 is connected to a network 410 such as the Internet. The customer terminal 300 is a portable information processing device which is capable of being connected to the network 410 via a wireless telephone circuit 420 for communication. It should be noted that a plurality of cash registers 200 and customer terminals 300 actually exist according to the number of retail stores and the number of customers. In addition, a plurality of manufacturer servers 100 may be installed for each manufacturer providing products or for each kind of products provided by each manufacturer.

As information storage media to be attached to the product 1a, a wireless ID tag 10a is used. The cash register 200 can read/write data from/to this tag 10a, while the customer terminal 300 can read the tag 10a.

The wireless ID tag 10a to be attached to the product 1a will be now described. The tag 10a has an integrated circuit (IC) chip of only few millimeter squares with a radio frequency circuit (RF) for wireless communication with a memory storing data. For example, by wireless communication of a short distance, for example, several tens centimeters, received data can be stored in the memory or read data can be sent. This wireless ID tag 10a receives radio waves from an external reader/writer (R/W) with its antenna, so as to generate electromagnetic induction to operate.

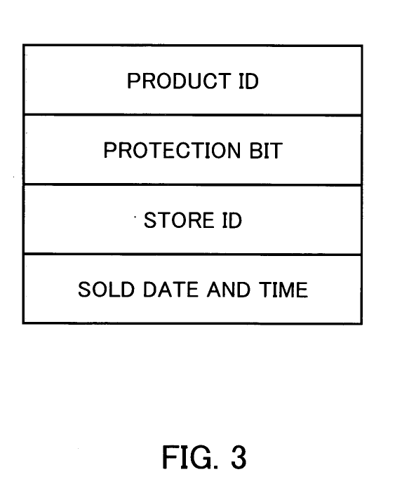

FIG. 3 shows the data structure in the wireless ID tag 10a.

Referring to FIG. 3, stored in the wireless ID tag 10a are a product ID, and a protection bit indicating whether to allow the customer terminal 300 to read data from the tag 10a. In addition to these items, a store ID indicating a retail store which sold the product 1a and a sold date and time can be stored. The product ID is desirably unerasable.

The product ID is written in the wireless ID tag 10a in advance at the time of shipping from the manufacturer or of manufacturing. The protection bit is initially “0”. Then, when the customer buys the product la, this bit is rewritten to “1” by the cash register 200.

Only when the protection bit is “1”, the customer terminal 300 can read the data from the wireless ID tag 10a. This protection bit proves that the product 1a was actually sold. Therefore, the customer can apply for an incentive to the manufacturer by obtaining the product ID only when he/she actually buys the product 1a.

In addition, the store ID indicating a retail store which sold the product 1a and the sold date and time can be written in the wireless ID tag 10a. These information are read by the customer terminal 300 together with the product ID and sent to the manufacturer server 100. If the cash register 200 of the retail store is designated to have a function to write data in the wireless ID tag 10a, the manufacturer can collect more detailed marketing information such as information on an area and retail store where the product was sold and a sold time, in addition to the information on a customer who bought the product 1a.

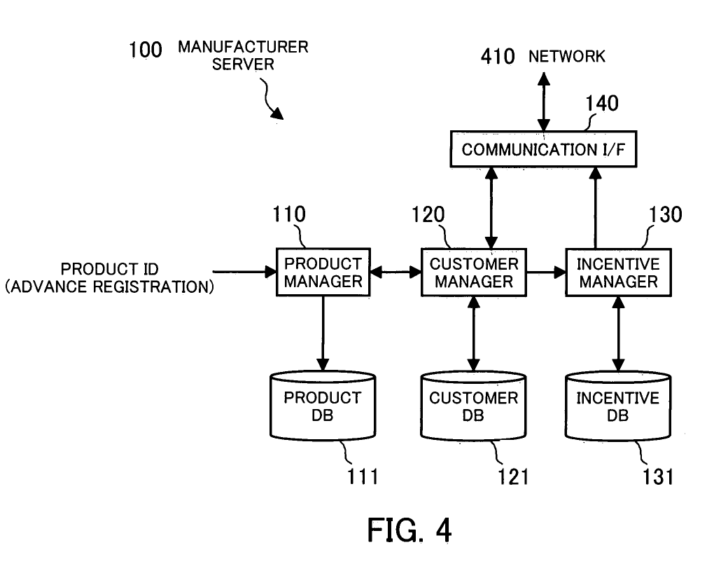

FIG. 4 is a functional block diagram of the manufacturer server 100.

The manufacturer server 100 is a computer-like device with processors, ROM/RAM, input device, and display. Referring to FIG. 4, this manufacturer server 100 functionally has a product manager 110, a customer manager 120, an incentive manager 130, a communication I/F 140, a product database (DB) 111, a customer DB 121, and an incentive DB 131.

The product manager 110, the customer manager 120 and the incentive manager 130 are functioned by a processor executing corresponding processing programs being stored in a hard disk drive (HDD).

The product manager 110 registers information in the product DB 111. This manager 110 stores the product IDs of products in the product DB 111 at the time of shipping. Then, when the manufacturer server 100 receives information from a customer who bought the product 1a, the product manager 110 receives this information via the customer manager 120, and searches the product DB 111 to determine whether the product 1a was actually sold. When the product manager 110 finds that the product 1a has not been sold, it stores the customer ID contained within the information from the customer in the product DB 111 by relating this customer ID to the product ID 111.

The customer manager 120 stores customer information on customers including a customer who bought the product 1a, in the customer DB 121. This manager 120 accepts customer registration by providing a Web site to register customer's personal information, to the customer terminal 300 of a customer, and then stores the personal information in the customer DB 121 and issues a customer ID to the sending customer. When the product 1a is sold, the customer manager 120 receives the product ID of the product and the customer ID, for example, via electronic mail via a communication I/F. After notifying the product manager 110 of the received information, the customer manager 120 makes the incentive manager 130 provide an incentive, as well as storing the information in the customer DB 121.

The incentive manager 130 updates the incentive DB 131 and provides incentives to customers. This manager 130 extracts corresponding incentive information in response to a request from the customer manager 120, and emails the customer with the incentive information via the communication I/F. At this time, this manager 130 updates the incentive DB 131 by storing the customer ID indicating the customer who receives the incentive.

The communication I/F 140 is connected to the network 410 for data communication. This communication I/F transfers data received via the network 410, to the customer manager 120 and sends data received from the customer manager 120 and the incentive manager 130, to its designation via the network 410.

Next explanation is about the data structure in each database.

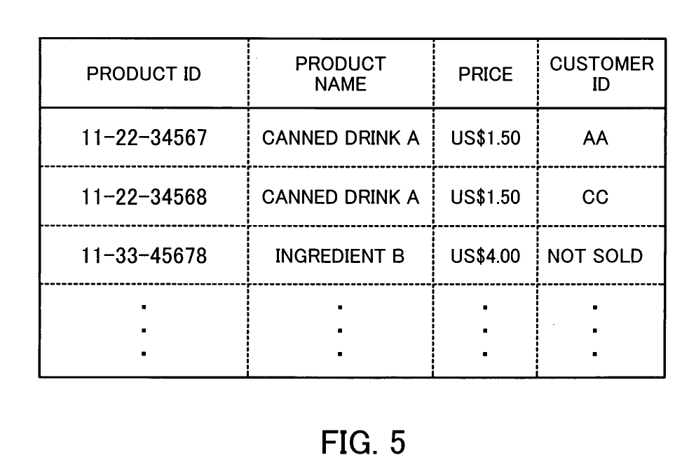

FIG. 5 shows the data structure in the product DB 111.

Referring to FIG. 5, stored in the product DB 111 are product IDs, names and prices, and the customer IDs of customers who purchased the products, in a relational structure, as information on the products 1a shipped. The product IDs, names and prices are stored at the time of shipping. For example, information on these items are entered by an operator after shipping the products 1a. For this process, the product manager 110 displays a product ID registration screen (not shown). The product manager 110 stores information entered by the operator on this screen, in the product DB 111. Alternatively, an external server which controls shipment of the products la may automatically send the product IDs, so that the manufacturer server 100 automatically receives and stores the IDs in the product DB 111 with the product manager 110.

The product ID in FIG. 5 is represented in nine digits, where the first two digits represent a manufacturer, next two a product type, and the last five a product.

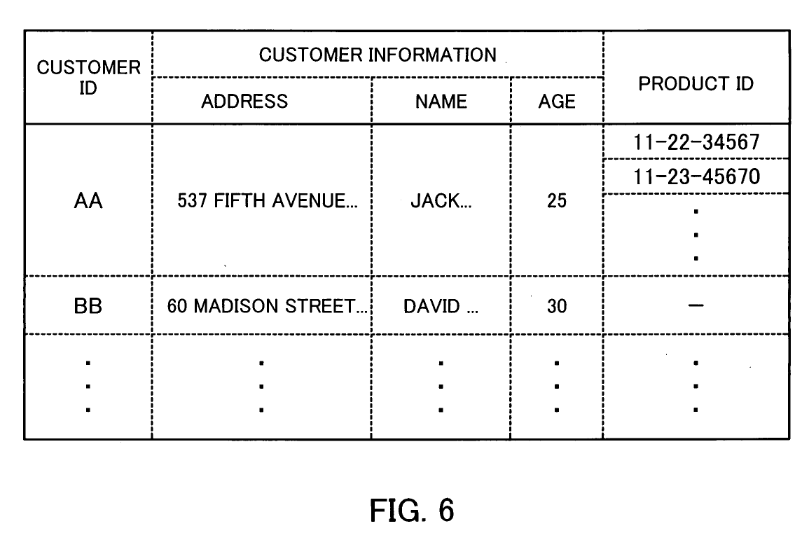

FIG. 6 shows the data structure in the customer DB 121.

Referring to FIG. 6, stored in the customer DB 121 are customer IDs identifying customers, customer information on the customers, and the product IDs of products that the customers purchased. The customer information includes customer's address, name and age or the like.

In a case where a customer has registered with a manufacturer before purchasing a manufacturer's product, space for the product ID of a product 1a purchased is null, like data on a customer with a customer ID “BB”.

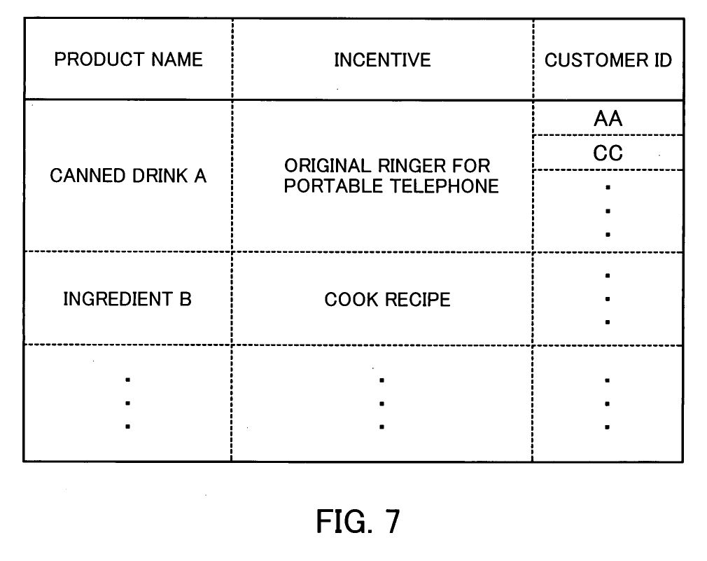

FIG. 7 shows the data structure in the incentive DB 131.

Referring now to FIG. 7, stored in the incentive DB 131 are product names as information identifying the type of product 1a, incentives for the products, and the customer IDs of customers who received the incentives in a relational structure. As the information identifying the product 1a, an identifier consist of the upper third and forth figures of its product ID may be used. In a case where an incentive is provided as electronic data, its file name may be stored as an incentive on condition that this incentive DB 131 has this electronic data as well.

In addition to these databases, the manufacturer server 100 may have a database for managing information on retail stores selling the products 1a. This database stores, for example, store IDs identifying retail stores, retail stores' names and addresses and the product IDs or names of the products 1a being sold. In the case where such a database is provided, the store IDs of retail stores which sold products and the sold dates and times may be stored together with the customer IDs of customers who bought the products, by being related to the product IDs in the product DB 111.

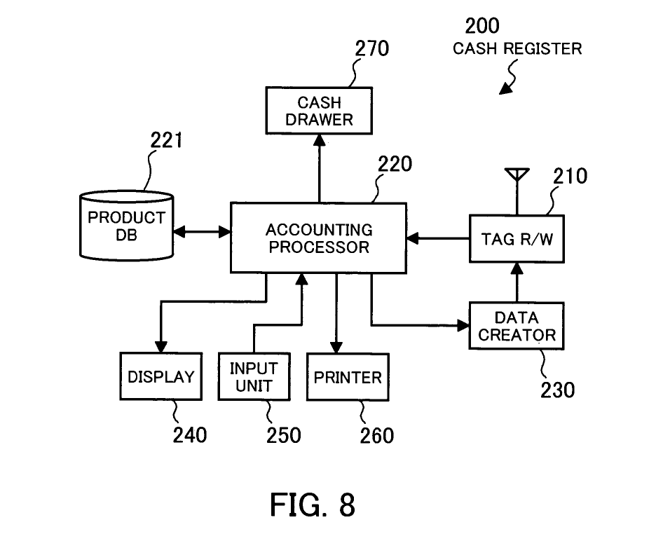

FIG. 8 shows a functional block diagram of the cash register 200 installed in a retail store.

Referring to FIG. 8, the cash register 200 functionally has a tag R/W 210, an accounting processor 220, a data creator 230, a product DB 221, a display 240, an input unit 250, a printer 260, and a cash drawer 270.

The tag R/W 210 reads the wireless ID tag 10a of the product 1a and outputs the read data to the accounting processor 220. In addition, the tag R/W 210 stores data received from the data creator 230 in the wireless ID tag 10a.

The product DB 221 initially stores therein the product IDs and prices of products 1a being sold at the retail store. The accounting processor 220 searches the product DB 221 for the price of the product 1a based on the product ID read by the tag R/W 210, and displays the price on the display 240. Then, the accounting processor 220 issues a receipt from the printer 260 and notifies the data creator 230 of the product ID of the product sold.

Upon reception of the product ID of the sold product 1a from the accounting processor 220, the data creator 230 makes the tag R/W 210 rewrite the protection bit of the wireless ID tag 10a to “1” and also store the store ID identifying this retail store and the sold date and time in this tag 10a.

The display 240 is composed of a fluorescent lamp or liquid crystal display (LCD). The input unit 250 is composed of input keys, and outputs entered data to the accounting processor 220 according to operations on the keys in the checkout process. The printer 260 issues a receipt by printing information received from the accounting processor 220. The cash drawer 270 contains coins and bills, and is open and closed under the control of the accounting processor 220.

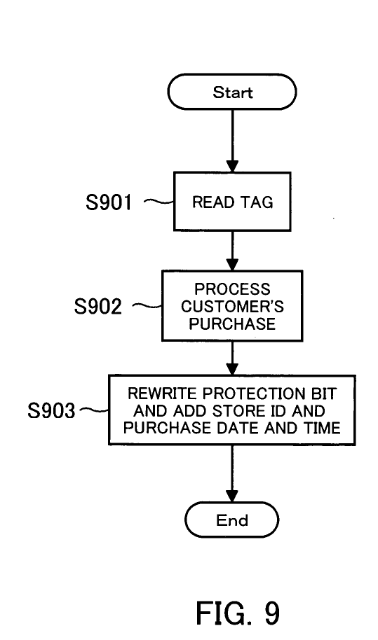

FIG. 9 is a flowchart of the checkout process of the cash register 200. The process in selling the product la will be described with reference to this flowchart.

The wireless ID tag 10a of a product at a retail store stores the product ID, and “0” as a protection bit. When the customer buys the product 1a, the following process will be conducted in the cash register 200.

At step S901, the tag R/W 210 reads the wireless ID tag 10a of the product 1a and outputs the read product ID to the accounting processor 220.

At step S902, the accounting processor 220 performs a checkout process. This processor 220 searches the product DB 221 for the price and displays it on the display 240 for checkout. By doing so, the retail store can use the product ID being stored in the wireless ID tag 10a in their Point Of Sales (POS) system for sales management.

After checkout, the printer 260 issues a receipt. In addition, at step S903, the accounting processor 220 sends a notice of the sold product ID to the data creator 230. The data creator 230 informs the tag R/W 210 of the store ID, the sold date and time and the product ID, so as to rewrite the protection bit of the wireless ID tag 10a of the sold product 1a to “1” and to newly add the store ID and the sold date and time in the tag 10a.

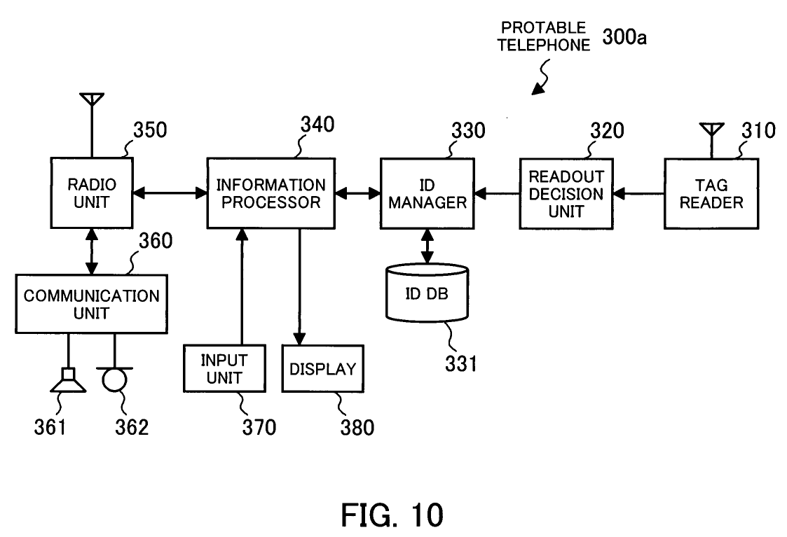

Next, a process after purchase of the product 1a will be described with a portable telephone 300a used as the customer terminal 300. FIG. 10 is a functional block diagram of the portable telephone applied as the customer terminal 300.

Referring to FIG. 10, the portable telephone 300a has a tag reader 310, a readout decision unit 320, an ID manager 330, an ID DB 331, an information processor 340, a radio unit 350, a communication unit 360, an input unit 370 and a display 380.

The tag reader 310 reads the wireless ID tag 10a of the product 1a and outputs the read data to the readout decision unit 320.

The readout decision unit 320 outputs the data to the ID manager 330 when the protection bit indicates “1”.

The ID DB 331 stores information identifying the manufacturer of a product 1a, a customer ID registered in the manufacturer server 100 of the manufacturer, and the product ID of a products purchased. When the information processor 340 registers customer information in a manufacturer server 100, the ID manager 330 stores the manufacturer name and a customer ID given from the manufacturer, in the ID DB 331. In addition, the ID manager 330 instructs the information processor 340 to apply for an incentive by sending information read from the wireless ID tag 10a, as well as storing the product ID received from the readout decision unit 320 in the ID DB 331. Upon reception of a transmission notification of information from the information processor 340, the ID manager 330 stores in the ID DB 331 such information that the information has been transmitted.

The information processor 340 communicates with the manufacturer server 100 via the radio unit 350 to register customer information in the manufacturer server 100 and to apply for an incentive by sending information to the manufacturer after purchase of a product 1a. In registering customer information, the information processor 340 displays a registration form obtained by accessing the manufacturer's Web site on the display 380, and transmits data entered on the registration form with the input unit 370 to the manufacturer server 100 via the radio unit 350.

The radio unit 350 demodulates radio signals received through the wireless telephone circuit 420 and supplies them to the information processor 340 and the communication unit 360, and modulates and converts data from these units into radio frequency signals and wirelessly transmits them through the wireless telephone circuit 420.

Connected to the communication unit 360 are a loudspeaker 361 and a microphone 362. The communication unit 360 amplifies audio signals demodulated by the radio unit 350, through a decoding process and D/A conversion, thus outputting sounds from the loudspeaker 361. In addition, this unit 360 applies A/D conversion and an encoding process to audio signals from the microphone 362 and transmits the resultant to the radio unit 350, so that communication can be made.

The input unit 370 is composed of ten keys and cursor keys, and outputs prescribed signals to the information processor 340 according to inputs entered by a customer. The display 380 is composed of, for example, a LCD, and displays images based on video signals from the information processor 340.

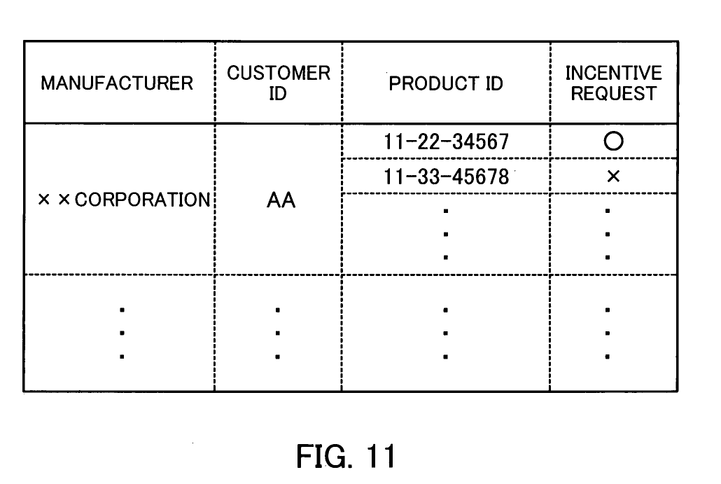

FIG. 11 shows the data structure in the ID DB 331.

Referring to FIG. 11, stored in the ID DB 331 are the names of manufacturers with which the customer information has been registered, customer IDs given from the manufacturers, product IDs indicative of products that the customer purchased, and incentive request information indicating whether the customer transmitted the product ID after purchase of a product.

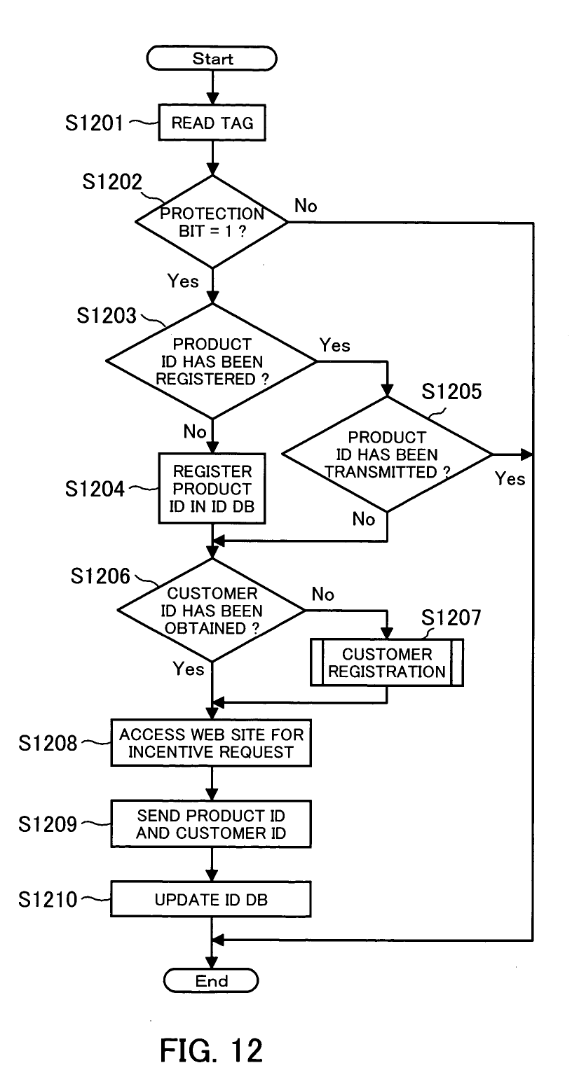

FIG. 12 is a flowchart showing a process of the portable telephone 300a after purchase of a product 1a. A process after the purchase of the product 1a will be described with reference to this flowchart. The process in the manufacturer server 100 will be also described.

At step S1201, the tag reader 310 reads the wireless ID tag 10a of the product 1a according to the operations of the customer who bought the product 1a and outputs the read data to the readout decision unit 320.

At step S1202, the readout decision unit 320 determines based on the protection bit whether to continue this process. The readout decision unit 320 outputs the read product ID, store ID and sold date and time to the ID manager 330 when the protection bit indicates “1”; and the readout decision unit 320 aborts this process by issuing a warning when the protection bit indicates “0”.

At step S1203, the ID manager 330 determines whether the received product ID exists in the ID DB 331. The process goes on to step S1205 when yes; and to step S1204, otherwise.

At step S1204, the ID manager 330 registers the received product ID in the ID DB 331. The process goes on to step S1206.

At step S1205, by reference to the ID DB 331, the ID manager 330 detects whether the read product ID has been transmitted to the manufacturer server 100, that is, whether the customer has applied for an incentive for the product 1a. When the product ID has not been transmitted, the process goes on to step S1206; and the process ends, otherwise.

At step S1206, :the ID manager 330 finds the manufacturer of the product 1a based on the read product ID and searches the ID DB 331 to determine whether the customer ID has been given from the manufacturer, that is, whether the customer information has been registered with the manufacturer. The information processor 340 is notified of the determination result. When the customer ID does not exist, the process goes on to step S1207; and to step S1208, otherwise.

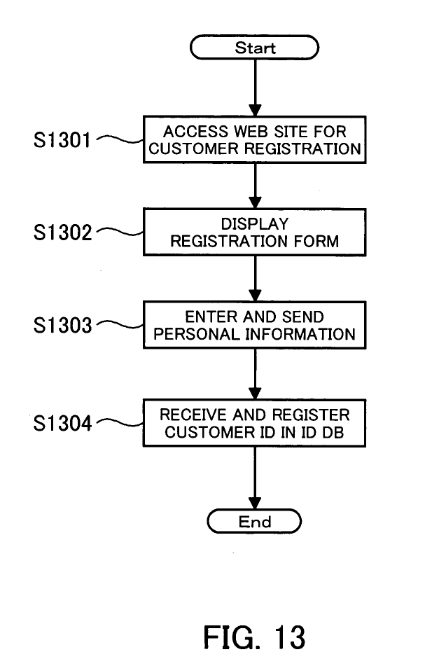

At step S1207, upon reception of the determination result, the information processor 340 registers customer information with the manufacturer. This process will be described in detail later with reference to FIG. 13. After the registration process, the process goes on to step S1208.

At step S1208, the information processor 340 accesses the manufacturer's web site for an incentive request via the radio unit 350. Thereby, the portable telephone 300a communicates with the manufacturer server 100 over the wireless telephone circuit 420 and the network 410. In the manufacturer server 100, the customer manager 120 sends control information via the communication I/F 140 so that the portable telephone 300a sends back information including the product ID of the purchased product 1a.

At step S1209, the information processor 340 transmits such information including the product ID, customer ID, store ID, and sold date and time received from the ID manager 330, to the manufacturer server 100 via the radio unit 350. The manufacturer server 100 receives the information and gives the received product ID to the product manager 110. In a case where the product ID has not been registered in the product DB 111, the product DB 111 and the customer DB 121 are updated. Then control information indicating the acceptance of the incentive request is transmitted to the portable telephone 300a.

At step S1210, upon reception of the acceptance from the manufacturer server 100, the ID manager 330 updates the ID DB 331 so as to indicate that product ID of the product 1a has been transmitted, and this process ends.

Now the customer registration process shown in step S1207 of FIG. 12 will be described.

FIG. 13 is a flowchart showing the customer registration process.

At step S1301, the information processor 340 accesses the manufacturer's web site for the customer information registration via the radio unit 350. Thereby the portable telephone 300a connects to the manufacturer server 100 over the wireless telephone circuit 420 and the network 410.

The manufacturer server 100 transmits screen data for a registration form to the portable telephone 300a via the communication I/F 140.

At step S1302, the information processor 340 displays this registration form on the display 380 based on the data received from the manufacturer server 100.

At step S1303, when the customer finishes to enter customer information with the input unit 370, the information processor 340 transmits this information to the manufacturer server 100 via the radio unit 350. The manufacturer server 100 registers the customer information in the customer DB 121 with the customer manager 120. At this time, a customer ID identifying the customer is created, registered in the customer DB 121, and transmitted to the portable telephone 300a.

At step S1304, upon reception of the customer ID from the manufacturer server 100, the ID manager 330 registers this ID in the ID DB 331.

After completing the above process successfully, the customer is able to receive an incentive from the manufacturer. After the manufacturer server 100 sends a notification of acceptance of the incentive request to the portable telephone 300a, it gives the product ID to the incentive manager 130 to search the incentive DB 131 for the corresponding incentive. In a case where the incentive is a gift, for example, an operator is notified of this incentive information and the incentive is shipped. After shipping, the incentive DB 131 is updated so as to indicate that the incentive has been sent.

In a case where the incentive is offered as electronic data such as music data for ringer of the portable telephone 300a, cook recipe, discount coupon or points, the manufacturer server 100 transmits this incentive to the portable telephone 300a, for example, via electronic mail. Alternatively, the incentive data can be sent to electronic mail addresses registered for receiving incentives at the time of the customer registration. After sending the incentive, the incentive DB 131 is updated.

It should be noted that a customer can register customer information in the manufacturer server 100 before purchasing the product 1a or before reading data from the purchased product 1a with the portable telephone 300. In this case, the customer makes the portable telephone 300a execute a process shown in FIG. 13 by operating the telephone 300a while viewing a Web site for customer information registration.

Out of the data to be stored in the ID DB 331, the product IDs indicating the purchased products and the incentive requests indicating whether the product IDs have been transmitted after purchase of the products 1a may be stored in an external device such as the manufacturer server 100 which is different from the portable telephone 300a. In this case, steps S1203, S1204 and S1210 are conducted by communicating with the external device.

In the system for collecting marketing information described above, a customer reads the product ID assigned to a purchased product 1a from the wireless ID tag 10a with a customer terminal 300 such as a portable telephone 300a and sends it to the manufacturer server 100. Therefore, the customer can easily apply for an incentive. This encourages more customers to send marketing information. Thus, the manufacturers can thus efficiently gather a larger number of marketing information on customers who bought their products 1a, so as to develop new products by correctly grasping demands for the products 1a. In addition, the manufacturers can expect increased sales of the products 1a.

Further, a protection bit prepared in the wireless ID tag 10 prevents dishonest customers from applying for incentives. In addition, since the cash register 200 of a retail store has a function to write data in the wireless ID tag 10a, information such as a store ID, sold date and time, other than a product ID, can be written in the wireless ID tag 10a. The customer terminal 300 is able to send this information to the manufacturer server 100 as well, so that the manufacturers can collect more variety of marketing information.

### (2) SECOND EMBODIMENT

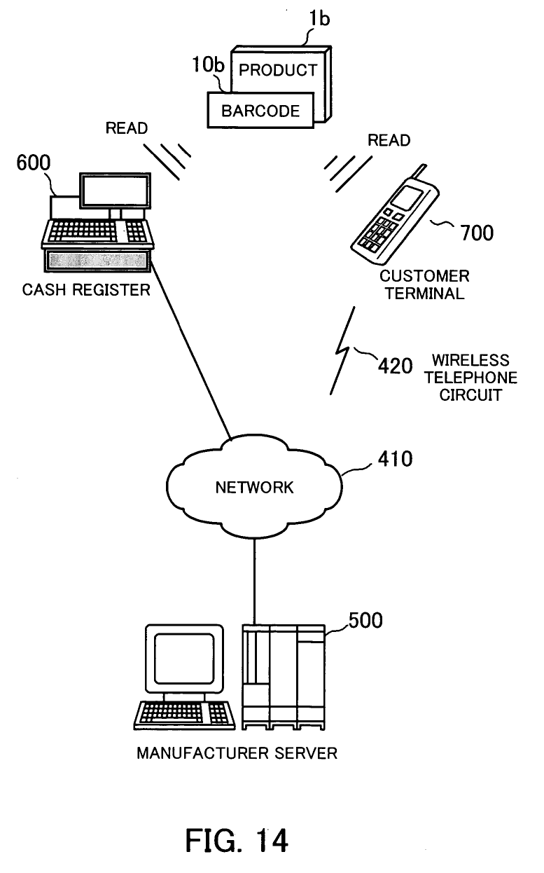

FIG. 14 shows a system for collecting marketing information according to the second embodiment of this invention. Elements identical to those in FIG. 2 have the same reference numerals and description of these elements is omitted.

As shown in FIG. 14, this system is composed of a manufacturer server 500, a cash register 600 placed in a retail store, and a customer terminal 700 of a customer. The manufacturer server 500 and the cash register 600 can communicate with each other over the network 410. The customer terminal 700 and the manufacturer server 500 can communicate with each other via a wireless telephone circuit 420 and the network 410. Alternatively, the manufacturer server 500 and the cash register 600 can be connected to each other via a leased line.

In this embodiment, information storage media, attached to a product 1b, which only allows data to be read is used. In this example, a two-dimensional barcode 10b is used as the information storage media. The two-dimensional barcode 10b stores the product ID identifying the product 1b as in the case of the first embodiment. The cash register 600 and the customer terminal 700 have barcode readers.

In this system for collecting marketing information, when a customer buys the product 1b, the cash register 600 reads the two-dimensional barcode 10b and transmits the read product ID to the manufacturer server 500 over the network 410. In addition, the customer also reads the barcode 10b with the customer terminal 700 and transmits the read product ID to the manufacturer server 500 over the wireless telephone circuit 420 and the network 410 to apply for an incentive.

The manufacturer server 500 offers the incentive to the customer only when the same product ID has arrived from the cash register 600 before the product ID and an incentive request are received from the customer terminal 700. That is, in this embodiment, the manufacturer server 500 determines if the customer actually purchased the product 1b, in order to provide the incentive.

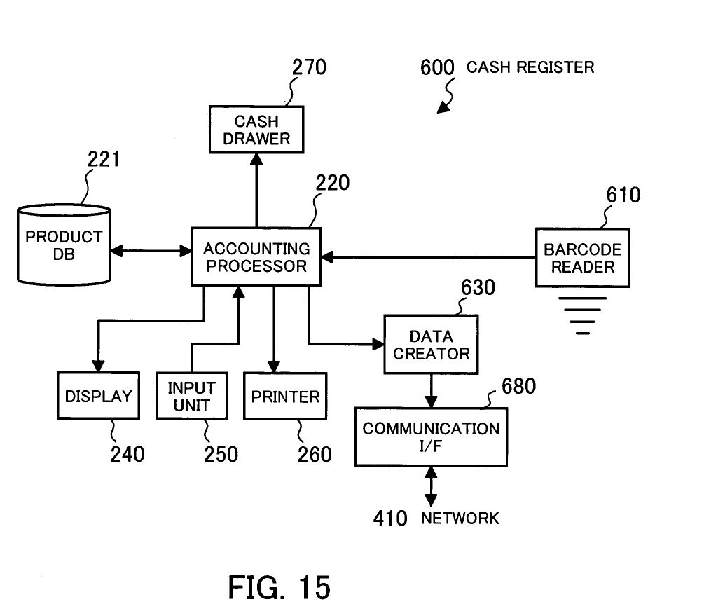

FIG. 15 is a functional block diagram of the cash register 600. Elements identical to those in FIG. 8 have the same reference numerals and description of these elements is omitted.

As shown in FIG. 15, in the cash register 600 of this embodiment, a barcode reader 610 reads a product ID from the two-dimensional barcode 10b of the product 1b and outputs the read product ID to an accounting processor 220. This processor 220 performs a checkout process based on the read product ID as in the case of the first embodiment, then outputs the product ID to a data creator 630 and ends the checkout process.

The data creator 630 creates data including the store ID indicating the retail store and the sold date and time as information to be transmitted to the manufacturer server 500, outputs the data together with the product ID to a communication I/F 680, and sends it to the manufacturer server 500 of the manufacturer of the product 1b via the network 410. The manufacturer server 500 is thus able to confirm that the retail store sold the product 1b.

Next, a process after purchase of the product 1b will be described, in which a portable telephone 700a is used as the customer terminal 700.

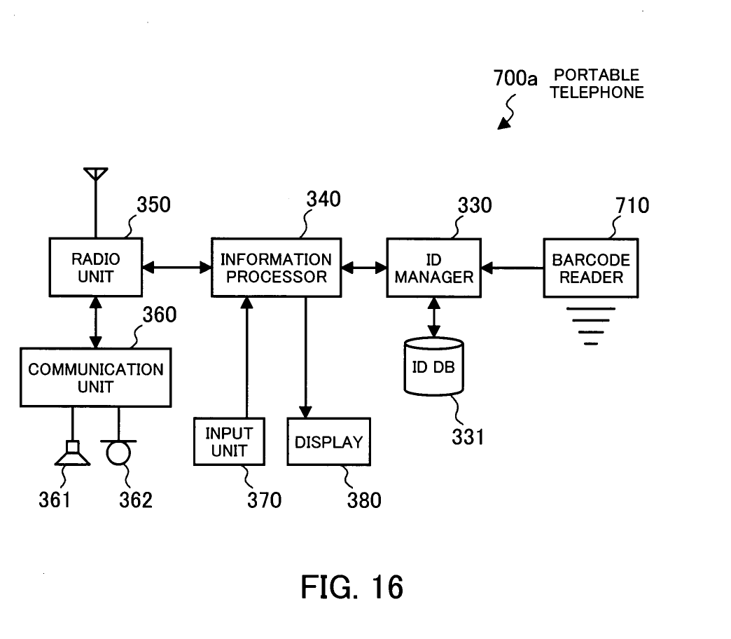

FIG. 16 is a functional block diagram of the portable telephone 700a. Elements identical to those in FIG. 10 have the same reference numerals and description of these elements is omitted.

The portable telephone 700a of this embodiment is provided with a barcode reader 710 for reading a product ID from the two-dimensional barcode 10b of a product 1b as shown in FIG. 16. The read product ID is given to an ID manager 330 without any process, unlike the first embodiment. Then, steps S1203 to S1210 in FIG. 12 are conducted to apply for an incentive to the manufacturer server 500. When the customer has registered his/her customer information, the portable telephone 700a transmits only the product ID and the customer ID to the manufacturer server 500.

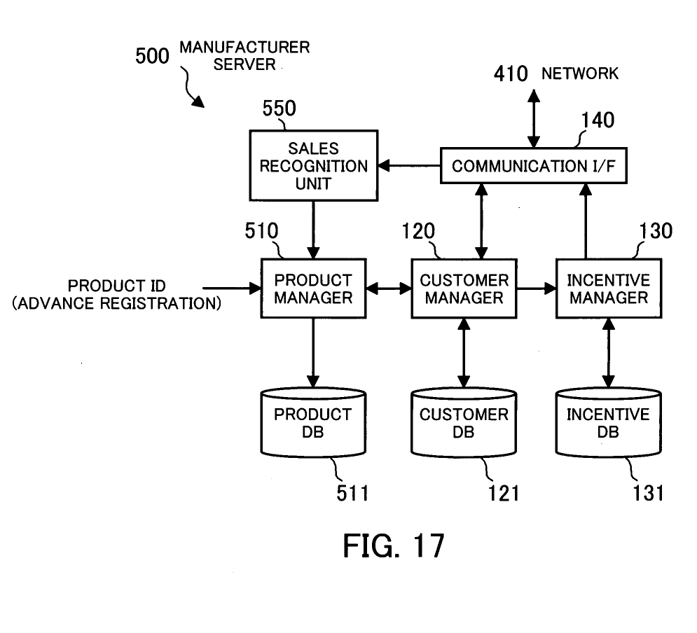

FIG. 17 is a functional block diagram of the manufacturer server 500. Elements identical to those in FIG. 4 have the same reference numerals and description of these elements is omitted.

In this embodiment, the manufacturer server 500 communicates with not only the customer terminal 700 but also the cash register 600. Information such as the product ID, store ID and sold date and time or the like from the cash register 600 is given to a sales recognition unit 550 from the communication I/F 140. The sales recognition unit 550 outputs the information to a product manager 510 which then registers the information in a product DB 511. In addition to the function to register information in the product DB 511 as described in the first embodiment, the product manager 510 has a function to search the product DB 511 to see whether a sold notice for a product ID has arrived when receiving the product ID from the customer terminal 700. This sold notice indicates that a product actually was sold.

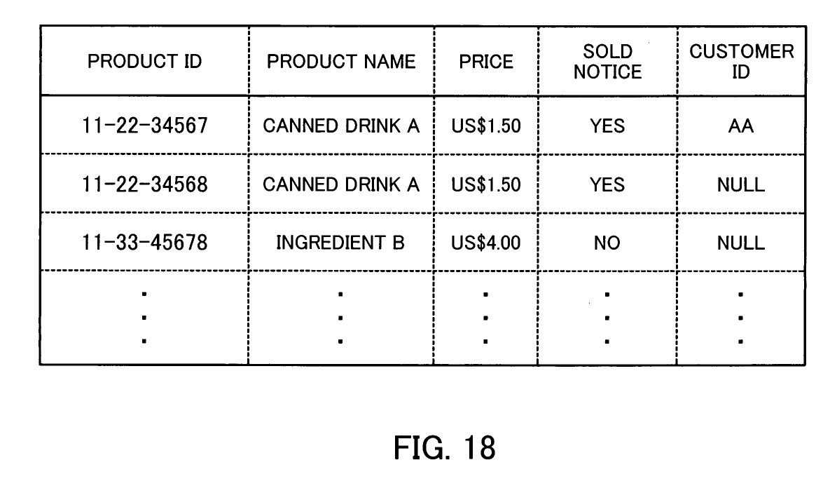

FIG. 18 shows the data structure in the product DB 511.

Referring to FIG. 18, stored in the product DB 511 are the product IDs, names and prices of products shipped, the customer IDs of customers who purchased the products, and presence or absence of sold notices from the cash register 600 of a retail store. The sold notice indicates that a product was actually sold. When information such as a product ID arrives from the cash register 600, “YES” is stored as a sold notice. When a product ID arrives from the customer terminal 700 thereafter, the customer ID is stored on condition that the corresponding sold notice indicates “YES”.

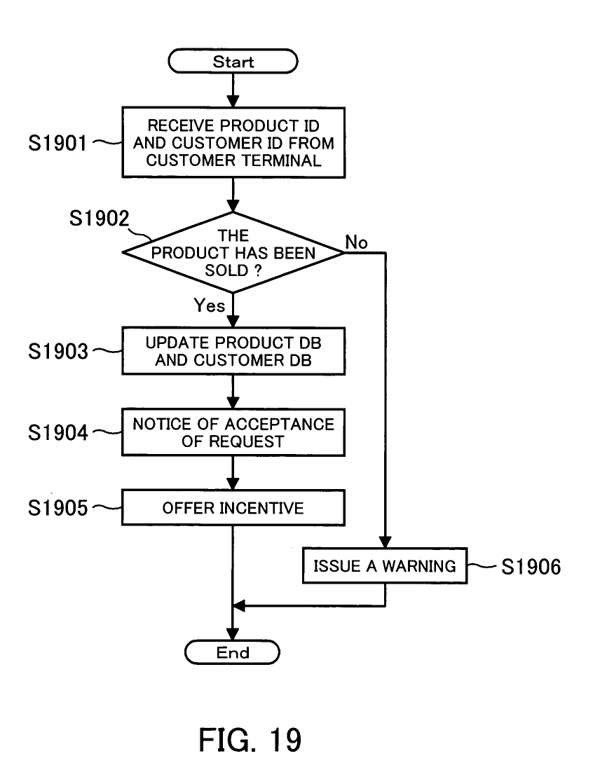

FIG. 19 is a flowchart of a process of the manufacturer server 500 when the customer terminal 700 applies for an incentive.

As in the case of the first embodiment, when the manufacturer server 500 receives an incentive request from the customer terminal 700, it transmits control information to the customer terminal 700 so that the terminal 700 sends back information including the product ID of the product 1b purchased.

At step S1901, the manufacturer server 500 receives the product ID and the customer ID from the customer terminal 700. These IDs are given to the customer manager 120.

At step S1902, the customer manager 120 informs the product manager 510 of the received product ID and customer ID. The product manager 510 searches the product DB 511 to determine whether a sold notice for the product ID has arrived from the cash register 600 of the retail store, and sends the resultant to the customer manager 120. The process goes on to step S1903 if the sold notice has arrived; and to step S1906, otherwise.

At step S1903, the product manager 510 stores the received customer ID by relating this ID to the product ID in the product DB. In addition, the customer manager 120 also updates the customer DB 121 with the received product ID and the customer ID depending on the determination result from the product manager 510.

At step S1904, the customer manager 120 informs the customer terminal 700 of the acceptance of the incentive request via the communication I/F 140, and disconnects the line.

At step S1905, notified of the product ID and the customer ID, the incentive manager 130 provides the corresponding incentive to the customer and then updates the incentive DB 131.

If the sold notice for the product ID has not arrived from the retail store, the incentive request from the customer terminal 700 is identified as invalid. Therefore at step S1906, the customer manager 120 issues a warning to the customer terminal 700.

Similar to the first embodiment, this second embodiment also enables customers to apply for incentives easily, so that manufacturers can efficiently gather a larger number of marketing information on customers who bought their products 1b. In addition, incentives can be provided to only rightful customers.

Furthermore, since any data is not necessarily added in the information storage media of a product 1b, the product cost can be minimized.

### (3) THIRD EMBODIMENT

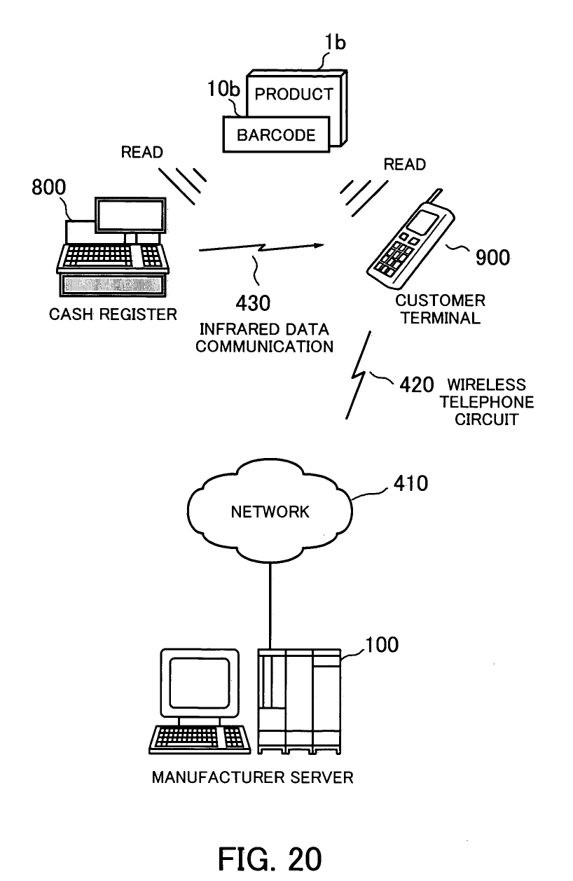

FIG. 20 shows a system for collecting marketing information according to the third embodiment of the present invention. Elements identical to those in FIG. 2 and 14 have the same reference numerals and description of these elements is omitted.

Referring to FIG. 20, this system for collecting marketing information according to this embodiment is composed of a manufacturer server 100, a cash register 800 placed in a retail store and a customer terminal 900 of a customer. The manufacturer server 100 has the same construction as that of the first embodiment. The customer terminal 900 can communicate with the manufacturer server 100 over a wireless telephone circuit 420 and a network 410.

Similarly to the second embodiment, information storage media, attached to a product 1b, which only allows data to be read is used. In this embodiment, a two-dimensional barcode 10b is used. The cash register 800 and the customer terminal 900 have barcode readers for the two-dimensional barcode 10b.

In addition, in this embodiment, infrared data communication 430 is used between the cash register 800 and the customer terminal 900. Alternatively, a short-distance wireless communication such as Bluetooth can be used.

In this system for collecting marketing information, the cash register 800 reads the two-dimensional barcode 10b and sends the read product ID to the customer terminal 900 by the infrared data communication 430 at the time of checkout. The customer terminal 900 stores the received product ID in a purchase history. Then the customer reads the product ID from the two-dimensional barcode 10b with the customer terminal 900. Only when the purchase history already includes the identical product ID, the customer is allowed to apply for an incentive. This prevents dishonest incentive requests.

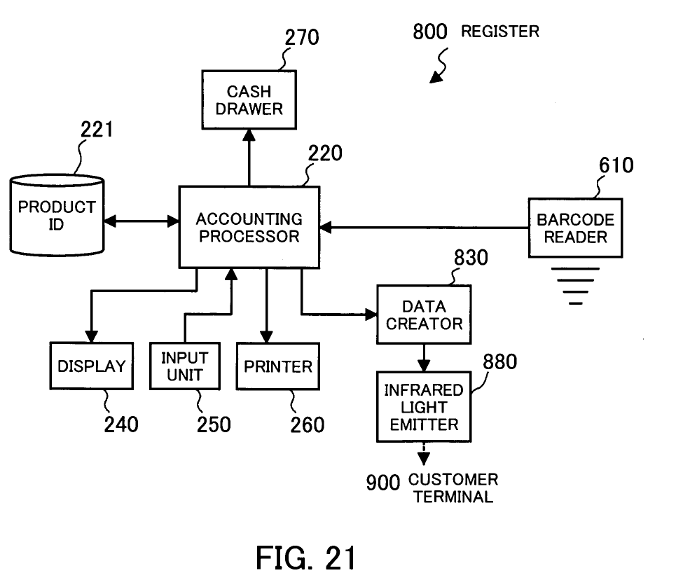

FIG. 21 is a functional block diagram of the cash register 800. Elements identical to those in FIGS. 8 and 15 have the same reference numerals, and description of these elements is omitted.

Referring to FIG. 21, in the cash register 800 of this embodiment, a barcode reader 610 reads the two-dimensional barcode 10b of the product 1b and outputs the read product ID to an accounting processor 220. As in the case of the first embodiment, the accounting processor 220 performs a checkout process based on the product ID and then notifies a data creator 830 of the completion of the checkout by outputting the product ID.

The data creator 830 creates data such as the store ID identifying the retail store and the sold date and time as information to be transmitted to the customer terminal 900, and then outputs the data together with the product ID to an infrared light emitter 880, so as to transmit them by the infrared data communication 430. Thereby the customer terminal 900 is notified that the product 1b has been sold at the retail store.

A process after purchase of the product 1b will be now described with a portable telephone 900a used as the customer terminal 900.

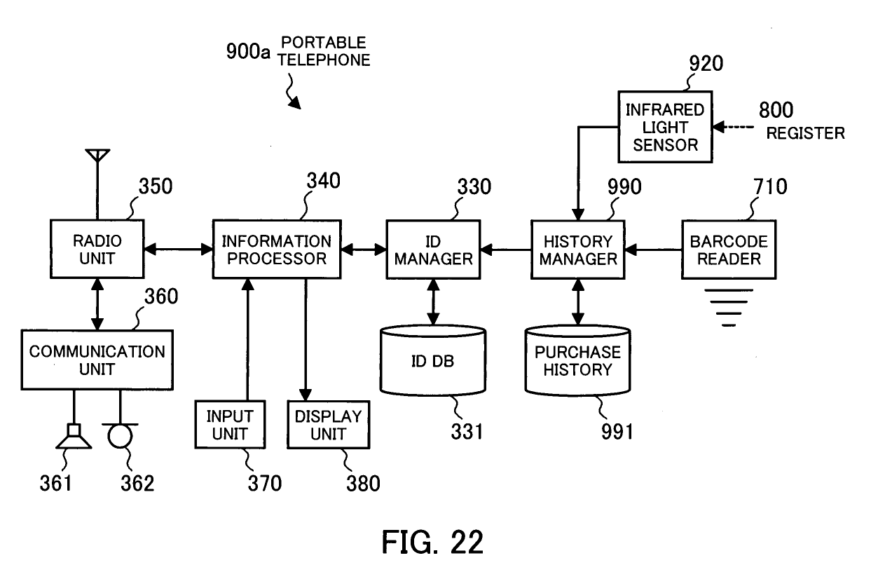

FIG. 22 is a functional block diagram of the portable telephone 900a. Elements identical to those in FIGS. 10 and 16 have the same reference numerals and description of these elements is omitted.

As shown in FIG. 22, the portable telephone 900a of this embodiment has an infrared light sensor 920 to receive data from the cash register 800 at the time of checkout. A barcode reader 710 reads the product ID from the two-dimensional barcode 10b of the product 1b.

A history manager 990 stores the product ID, store ID, and sold date and time received by the infrared light sensor 920, to manage them as a purchase history. In addition, when the history manger 990 receives a product ID from the barcode reader 710, it searches the purchase history 991 for the identical product ID. If the identical ID is not detected, the history manager 990 issues a warning to the customer. When detected, on the contrary, the history manager 990 gives the read product ID together with the store ID and the sold date and time to the ID manager 330. Then, steps S1203 to S1210 in FIG. 12 are conducted to apply for an incentive to the manufacturer server 100.

This system for collecting marketing information enables customers to apply for incentives easily, so that manufacturers can efficiently gather a larger number of marketing information on customers who bought their products 1b.

By the way, in recent years, payment at retail -stores with electronic money by using portable information processing terminals such as portable telephones has come to be considered. If customers automatically can get discounts provided as incentives, they will try to apply for incentives more often. Since the customers can receive incentives via electronic mail from manufacturers in the foregoing embodiments, discounts at payment can be realized. Especially, the third embodiment can easily realize discount at payment because the customer terminal is able to receive the product ID directly from the register, that is, the customers are able to receive incentives from the manufacturers at the time of checkout.

As described above, in the system for collecting marketing information of this invention, customers can electronically obtain product identification information assigned to a product, so as to easily inform the manufacturers of the product identification information and customer information with the customer terminals. As a result, the customers are able to easily apply for incentives while the manufacturers are able to gather a larger number of marketing information and, in turn, to promote product sales.

Further, since read-permission information is stored by a retail terminal in the information storage media attached to a product at the time of checkout, product identification information can be read only when the information storage media stores this read-permission information. This avoids customers from applying or incentives dishonestly. Alternatively, a retail terminal reads and transmits product identification information from the information storage media to a manufacturer server at the time of checkout. Then when information arrives from a customer terminal, the manufacturer server determines the validity of the received information according to the existence or absence of the identical product identification information. This rejects dishonest incentive requests.

Thus this invention enables effective collection of a larger number of marketing information and provision of incentives.

The foregoing is considered as illustrative only of the principles of the present invention. Further, since numerous modifications and changes will readily occur to those skilled in the art, it is not desired to limit the invention to the exact construction and applications shown and described, and accordingly, all suitable modifications and equivalents may be regarded as falling within the scope of the invention in the appended claims and their equivalents.

What is claimed is:

1. A system for collecting marketing information enabling a product provider to gather marketing information and offer incentives for the marketing information, comprising:
information storage media, with a product, storing at least product identification (ID) information identifying the product;
a retail terminal comprising an information writer for writing read-permission information in the information storage media at a time of checkout so as to allow the product ID information to be read; and
a product provider server comprising:
a customer information receiver for receiving the product ID information read from the information storage media and customer information on a customer purchasing the product from a customer terminal of the customer; and
an information management unit for storing the product ID information received and the customer information received in a relational structure and for managing a provision status of incentives offered to the customer who provided the product ID information and the customer information.

2. The system according to claim 1, wherein the product provider server further comprises an incentive transmitter for transmitting electronic data with an incentive to an address specified by the customer who provided the product ID information and the customer information.

3. The system according to claim 2, wherein in the product provider server the incentive transmitter transmits the electronic data with the incentive to the address immediately after receiving the product ID information and the customer information from the customer information receiver.

4. The system according to claim 1, wherein in the product provider server the customer information receiver receives personal information on the customer as the customer information together with the product ID information.

5. The system according to claim 1, wherein in the product provider server:
the information management unit stores personal information on the customer registered in advance, and customer ID information for identifying the customer in a relational structure; and
the customer information receiver receives the customer ID information as the customer information which is notified to the customer after customer registration.

6. The system according to claim 1, wherein in the retail terminal the information writer further stores store information on a retail store selling the product in the information storage media and wherein in the product provider server the customer information receiver receives the store information read from the information storage media, together with the product ID information and the customer information.

7. The system according to claim 1, wherein in the retail terminal the information writer further stores sold date and time information of the product in the information storage media and wherein in the product provider server the customer information receiver receives the sold date and time information read from the information storage media, together with the product ID information and the customer information.

8. The system according to claim 1, wherein the information storage media is a wireless ID tag.

9. A system for collecting marketing information enabling a product provider to gather marketing information and offer incentives for the marketing information, comprising:
information storage media, with a product, storing at least product identification (ID) information identifying the product;
a retail terminal comprising:
an information reader for reading the information from the information storage media; and
an ID information transmitter for transmitting the product ID information at a time of checkout; and
a product provider server comprising:
an ID information receiver for receiving the product ID information from the retail terminal;
a customer information receiver for receiving the product ID information read from the information storage media and customer information on a customer purchasing the product from a customer terminal of the customer;
a sales recognition unit for identifying the product ID information and the customer information received from the customer terminal as valid information when a same product ID information has arrived from the retail terminal, and allowing provision of an incentive to the customer; and
an information management unit for storing the product ID information and the customer information from the customer terminal in a relational structure and managing a provision status of incentives offered to the customer, depending on recognition of the sales recognition unit.

10. The system according to claim 9, wherein in the retail terminal the ID information transmitter transmits store information on a retail store selling the product together with the product ID information to the product provider server.

11. The system according to claim 10, wherein in the retail terminal the ID information transmitter transmits sold date and time information of the product together with the product ID information to the product provider server.

12. The system according to claim 9, wherein the information storage media is a two-dimensional barcode.

13. A system for collecting marketing information enabling a product provider to gather marketing information and offer incentives for the marketing information, comprising:
information storage media, with a product, storing at least product identification (ID) information identifying the product;
a retail terminal comprising:
a first information reader for reading the information from the information storage media; and
an ID information transmitter for transmitting the product ID information read from the information storage media at a time of checkout;
a product provider server comprising:
a customer information receiver for receiving the product ID information which is identically obtained from both the retail terminal and the information storage media, and customer information on a customer purchasing the product, from a customer terminal of the customer; and
an information management unit for storing the product ID information received and the customer information received in a relational structure, and for managing a provision status of incentives offered to the customer.

14. An information processing terminal for transmitting marketing information to a product provider after purchase of a product, comprising:
an information reader for reading information from information storage media of the product, which unit stores at least product identification (ID) information identifying the product; and
an information transmitter for transmitting the product ID information together with customer information on a customer purchasing the product, to a server of the product provider.

15. The information processing terminal according to claim 14, further comprising
a transmission determination unit for allowing the information transmitter to transmit the product ID information only when the information read from the information storage media by the information reader includes read-permission information.

16. The information processing terminal according to claim 14, further comprising:
an information receiver for receiving the product ID information from a retail terminal of a retail store at a time of checkout; and
a transmission determination unit for allowing the information transmitter to transmit the product ID information only when product ID information identical to the product ID information received has arrived from the retail terminal before the information reader reads the product ID information.

17. The information processing terminal according to claim 14, wherein
the information transmitter transmits the product ID information and the customer information to the server via a wireless telephone circuit.
